(19) United States
(12) Patent Application Publication
(10) Pub. No.: US 2025/0327832 A1
(43) Pub. Date: Oct. 23, 2025

(54) Inertial Sensor Module

(71) Applicant: SEIKO EPSON CORPORATION, Tokyo (JP)

(72) Inventor: Shinichi MITSUNAGA, Shiojiri (JP)

(21) Appl. No.: 19/185,726

(22) Filed: Apr. 22, 2025

(30) Foreign Application Priority Data
Apr. 23, 2024 (JP) 2024-069575

(51) Int. Cl. G01P 15/02; G01P 15/18

(52) U.S. Cl. CPC G01P 15/02; G01P 15/18

(57) ABSTRACT

There is configured an inertial sensor module including an inertial sensor unit and N (N is an integer no smaller than 2) arithmetic processing devices, wherein the N arithmetic processing devices start sampling and output a processing result in a predetermined order.

The present application is based on, and claims priority from JP Application Serial Number 2024-069575, filed Apr. 23, 2024, the disclosure of which is hereby incorporated by reference herein in its entirety.

### BACKGROUND

### 1. Technical Field

The present disclosure relates to an inertial sensor module.

### 2. Related Art

In the past, there has been known a configuration in which an output from an inertial sensor device is processed by an arithmetic processing device. For example, JP-A-2019-163955 discloses a configuration in which an X-axis angular velocity sensor device, a Y-axis angular velocity sensor device, a Z-axis angular velocity sensor device, and an acceleration sensor device are coupled to a microcontroller (arithmetic processing device). The microcontroller performs arithmetic processing based on outputs from these sensor devices.

JP-A-2019-163955 is an example of the related art.

In the related art, signals from the plurality of sensor devices are processed by the single microcontroller. Therefore, the microcontroller is required to have high performance capable of processing the signals of the plurality of sensor devices, which becomes an obstacle for configuring a sensor module that operates at high speed. Therefore, there is a demand for a technique capable of increasing the speed with a more simplified configuration compared to the configuration in which the signals from the plurality of sensor devices are processed by the single microcontroller.

### SUMMARY

An inertial sensor module as an embodiment for solving the problem described above includes an inertial sensor unit, and N (N is an integer no smaller than 2) arithmetic processing devices configured to perform sampling of an output of the inertial sensor unit, processing based on a sampling result, and output of a processing result, wherein the N arithmetic processing devices are configured to start the sampling and output the processing result in a predetermined order.

### BRIEF DESCRIPTION OF THE DRAWINGS

FIG. 1 is a diagram showing a configuration example of an inertial sensor module according to a first embodiment.

FIG. 2 is a timing chart of operations and so on of elements of the inertial sensor module according to the first embodiment.

FIG. 3 is a diagram showing a configuration example of an inertial sensor module according to a second embodiment.

FIG. 4 is a timing chart of operations and so on of elements of the inertial sensor module according to the second embodiment.

FIG. 5 is a diagram showing a configuration example of an inertial sensor module according to a third embodiment.

FIG. 6 is a timing chart of operations and so on of elements of the inertial sensor module according to the third embodiment.

FIG. 7 is a diagram showing a configuration example of an inertial sensor module according to a fourth embodiment.

### DESCRIPTION OF EMBODIMENTS

Some preferred embodiments of the present disclosure will hereinafter be described in detail. Note that the embodiments described below do not limit the contents of the present disclosure set forth in the appended claims, and all the configurations described in the embodiments are not necessarily essential as solution elements of the present disclosure.

### (1) First Embodiment

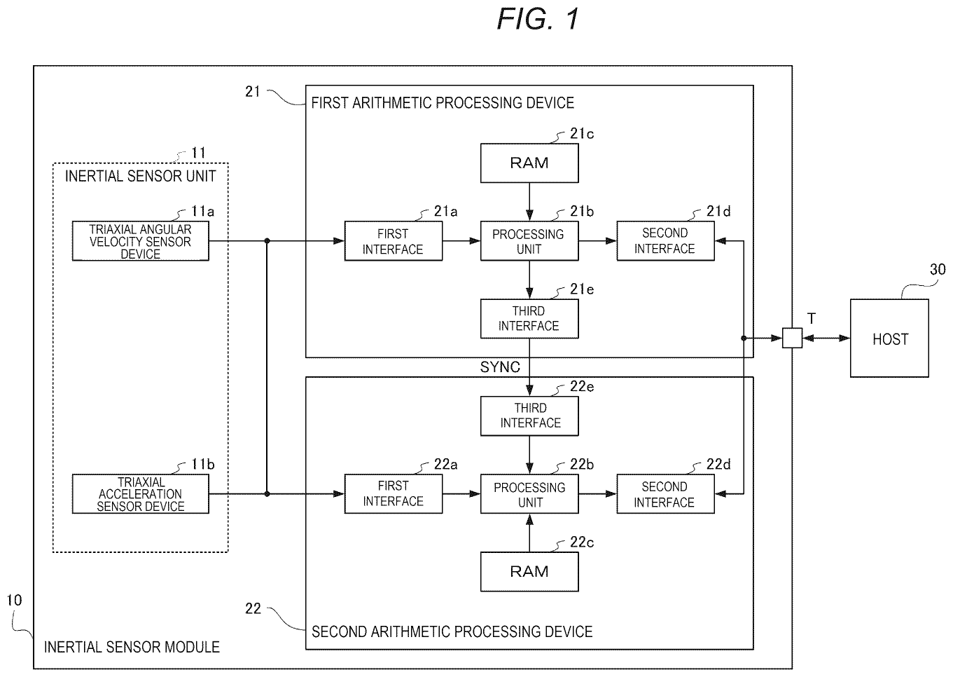

FIG. 1 shows a configuration example of an inertial sensor module 10 according to the present embodiment. In the present embodiment, the inertial sensor module 10 is coupled to a host 30 so as to be able to communicate with each other. The inertial sensor module 10 and the host 30 communicate with each other according to a predetermined communication standard (e.g., the SPI standard).

The inertial sensor module 10 is a module including a plurality of sensor elements that detect values related to inertia. In the present embodiment, the inertial sensor module 10 includes an inertial sensor unit 11, a first arithmetic processing device 21, and a second arithmetic processing device 22.

In the present embodiment, the inertial sensor unit 11 includes a triaxial angular velocity sensor device 11a and a triaxial acceleration sensor device 11b. The triaxial angular velocity sensor device 11a is a sensor that detects angular velocities. The triaxial angular velocity sensor device 11a includes sensor elements that detect angular velocities in rotational directions around respective rotational axes corresponding to three axes set in advance and perpendicular to each other. The triaxial angular velocity sensor device 11a detects, for example, an angular velocity around the X axis, an angular velocity around the Y axis, and an angular velocity around the Z axis. Further, the triaxial angular velocity sensor device 11a includes an analog circuit, an A/D conversion circuit, and an interface (not shown). When the triaxial angular velocity sensor device 11a detects the angular velocities, predetermined processing is performed on a detection result by the analog circuit, and analog signals representing the angular velocities thus processed are converted into digital data by the A/D conversion circuit. The digital data output from the A/D conversion circuit is output to the first arithmetic processing device 21 and the second arithmetic processing device 22 via the interface.

The triaxial acceleration sensor device 11b is a sensor that detects acceleration. The triaxial acceleration sensor device 11b includes sensor elements each detecting acceleration in a direction along each of the three axes set in advance and perpendicular to each other. The triaxial acceleration sensor device 11b detects, for example, acceleration in the X-axis direction, acceleration in the Y-axis direction, and acceleration in the Z-axis direction. Further, the triaxial acceleration sensor device 11b also includes an analog circuit, an A/D conversion circuit, and an interface. That is, analog signals each representing the acceleration detected by the sensor element are processed by the analog circuit, then converted into digital data by the A/D conversion circuit, and then output to the first arithmetic processing device 21 and the second arithmetic processing device 22.

The predetermined processing executed by the analog circuit in the triaxial angular velocity sensor device 11a and the triaxial acceleration sensor device 11b may be various types of processing. The analog circuit may include, for example, an amplifier circuit which amplifies the signals from the sensor elements, a detection circuit such as a synchronous detection circuit, a gain adjustment circuit, and an offset adjustment circuit. As an A/D conversion method of the A/D conversion circuit, various methods can be adopted. For example, a successive approximation type, a delta-sigma type, a flash type, a pipeline type, or a double integration type can be adopted. As an interface which outputs the digital data from the sensors to the first arithmetic processing device 21 and the second arithmetic processing device 22, there can be adopted, for example, an interface for transmitting and receiving serial data. Specifically, these interfaces perform interface processing compliant with a communication standard such as SPI or I²C. Alternatively, interface processing compliant with a communication standard obtained by advancing the SPI or I²C standard, or a communication standard obtained by partially improving or modifying the SPI or I²C standard may be performed. In the present embodiment, digital data representing the angular velocity and the acceleration about each of the three axes is serially output. Note that in the communication standard such as SPI or I²C, a plurality of wiring lines is used for communication in some cases, but in the drawings, the plurality of wiring lines is not clearly shown but is schematically represented by a single line (the same applies the following).

In the present embodiment, the triaxial angular velocity sensor device 11a and the triaxial acceleration sensor device 11b are coupled to the first arithmetic processing device 21 and the second arithmetic processing device 22 with electrically conductive signal lines.

Therefore, the digital data output from each of the triaxial angular velocity sensor device 11a and the triaxial acceleration sensor device 11b can be obtained by both the first arithmetic processing device 21 and the second arithmetic processing device 22.

The first arithmetic processing device 21 includes a first interface 21a, a processing unit 21b, a RAM 21c, a second interface 21d, and a third interface 21e. In the present embodiment, the first arithmetic processing device 21 is an integrated circuit device and can be realized by a processor such as an MPU or a CPU. Alternatively, the first arithmetic processing device 21 may be implemented with an ASIC using automatic layout and wiring such as a gate array.

Further, in the present embodiment, the processing unit 21b is a function implemented by executing a predetermined program. On the other hand, the first interface 21a, the RAM 21c, the second interface 21d, and the third interface 21e are realized by hardware.

The RAM 21c is a memory capable of storing any information. In the present embodiment, configuration information and information used for correction processing are stored in the RAM 21c. The configuration information is information for designating a mode and various operations of the first arithmetic processing device 21. The information used for the correction processing is information for correcting temperature characteristics of the sensor elements, or the like.

The first interface 21a, the second interface 21d, and the third interface 21e are interfaces for performing data communication between the first arithmetic processing device 21 and other devices. For example, the first interface 21a is an interface for the first arithmetic processing device 21 to acquire the digital data output from the triaxial angular velocity sensor device 11a and the triaxial acceleration sensor device 11b.

The second interface 21d is an interface for the first arithmetic processing device 21 to acquire a command output from the host 30 and to transmit digital data output from the first arithmetic processing device 21 to the host 30. The third interface 21e is an interface for exchanging a synchronization signal SYNC for the first arithmetic processing device 21 to operate in synchronization with the second arithmetic processing device 22 between the first arithmetic processing device 21 and the second arithmetic processing device 22.

The processing unit 21b performs predetermined processing based on the output of the inertial sensor unit 11. Specifically, the processing unit 21b performs sampling of the output of the inertial sensor unit 11, processing based on the sampling result, and output of the processing result. The sampling is processing of sequentially acquiring output values serially output from the triaxial angular velocity sensor device 11a and the triaxial acceleration sensor device 11b. In the present embodiment, the first arithmetic processing device 21 performs sampling at a predetermined sampling period. That is, the processing unit 21b starts sampling the output of the inertial sensor unit 11 at a predetermined timing, and then sequentially acquires the angular velocities of the three axes and the acceleration values of the three axes output from the inertial sensor unit 11 via the first interface 21a. Then, when a predetermined sampling period elapses after starting the sampling, the processing unit 21b starts sampling again.

When the sampling is performed, the processing unit 21b performs various types of processing based on the angular velocities of the three axes and the acceleration values of the three axes thus acquired. Examples of the various types of processing include correction of an output error caused by temperature characteristics of the triaxial angular velocity sensor device 11a and the triaxial acceleration sensor device 11b.

When the various types of processing are performed, the processing unit 21b outputs values obtained by the processing, that is, the triaxial angular velocity values and the triaxial acceleration values to the host 30 via the second interface 21d. Note that the processing unit 21b can perform various types of processing besides the above processing. For example, the processing unit 21b can execute processing according to a command from the host 30, processing for synchronizing the first arithmetic processing device 21 and the second arithmetic processing device 22 with each other, and so on.

The second arithmetic processing device 22 has substantially the same configuration as that of the first arithmetic processing device 21 and can execute substantially the same function. However, the processing unit 21b of the first arithmetic processing device 21 can execute processing of generating the synchronization signal SYNC to output the synchronization signal SYNC to the second arithmetic processing device 22 via the third interface 21e. The first arithmetic processing device 21 and the second arithmetic processing device 22 can start processing based on the synchronization signal SYNC. That is, in the present embodiment, the first arithmetic processing device 21 and the second arithmetic processing device 22, which are two arithmetic processing devices, determine the timing to start sampling in accordance with the common synchronization signal. According to this configuration, it is possible to synchronize the first arithmetic processing device 21 and the second arithmetic processing device 22 with each other with a simple configuration.

In the present embodiment, the first interface 21a provided to the first arithmetic processing device 21 is electrically coupled to the triaxial angular velocity sensor device 11a and the triaxial acceleration sensor device 11b of the inertial sensor unit 11. Further, a first interface 22a provided to the second arithmetic processing device 22 is coupled to the triaxial angular velocity sensor device 11a and the triaxial acceleration sensor device 11b of the inertial sensor unit 11. The signal line coupled to the first interface 21a and the signal line coupled to the first interface 22a are electrically coupled to each other. Therefore, both the first arithmetic processing device 21 and the second arithmetic processing device 22 can acquire the digital data output from the triaxial angular velocity sensor device 11a and the triaxial acceleration sensor device 11b.

In the present embodiment, the second interface 21d and a second interface 22d are each an interface for communicating with the host 30, and are each electrically coupled to a terminal T with electrically conductive signal lines. The host 30 is electrically coupled to the inertial sensor module 10 with the terminal T. Therefore, the host 30 acquires both signals output from the second interface 21d and the second interface 22d as signals output from the inertial sensor module 10.

Note that as the second interface 21d and the second interface 22d, there can be adopted, for example, interfaces that transmit and receive serial data. Specifically, these interfaces perform interface processing compliant with a communication standard such as SPI or I²C. Alternatively, interface processing compliant with a communication standard obtained by advancing the SPI or I²C standard, or a communication standard obtained by partially improving or modifying the SPI or I²C standard may be performed.

In the present embodiment, the inertial sensor module 10 operates in various modes. When the inertial sensor module 10 is powered on, initialization and so on are performed, and then the inertial sensor module 10 operates in a configuration mode. In the configuration mode, the inertial sensor module 10 can receive a configuration information instruction command. In the configuration mode, when a sampling start command is received or a predetermined transition condition is satisfied, the inertial sensor module 10 makes the transition to a sampling mode.

In the sampling mode, the angular velocities about the three axes and the acceleration values about the three axes detected by the inertial sensor unit 11 are transmitted from the inertial sensor module 10 to the host 30. Although various transmission aspects may be adopted, a burst mode in which continuous transfer of data is performed will be described here. The burst mode is a mode in which continuous transfer of data is performed in response to transmission of a command instructing execution of the continuous transfer from the host 30.

When the burst mode is started, the first arithmetic processing device 21 and the second arithmetic processing device 22 sample and then correct the output results of the triaxial angular velocity sensor device 11a and the triaxial acceleration sensor device 11b, and then output the results to the host 30. In the present embodiment, the first arithmetic processing device 21 and the second arithmetic processing device 22 start sampling every 1000 μs as a predetermined period (i.e., with a frequency of 1 kHz).

In order to perform sampling in a predetermined period, it is necessary to perform sampling, processing based on a sampling result, and output of a processing result within the predetermined period. Therefore, the first arithmetic processing device 21 and the second arithmetic processing device 22 need to have a performance capable of executing the processing described above within the predetermined period.

When achieving an increase in speed of the detection, it is conceivable to shorten the period at which the inertial sensor unit 11 performs the output. Note that the period at which the inertial sensor unit 11 performs the output is defined, in an operation in which the inertial sensor unit 11 starts the output, then ends the output, and then starts the output again, as a time length from the timing of starting the output to the timing of starting the subsequent output. However, when it is attempted that the output of the inertial sensor unit 11 with the period shortened is processed by a single arithmetic processing device, it is required for the period of the sampling by the arithmetic processing device to be equivalent to or shorter than the output period of the inertial sensor unit 11. Therefore, in order to increase the detection speed, it is necessary to increase the speed of the arithmetic processing device, and the configuration of the arithmetic processing device becomes complicated.

Therefore, in the present embodiment, there is adopted a configuration in which two arithmetic processing devices longer in operation period than the inertial sensor unit 11 are installed in the inertial sensor module 10 to thereby make the output period of the inertial sensor module 10 coincide with the output period of the inertial sensor unit 11. Specifically, in the present embodiment, the predetermined period at which the first arithmetic processing device 21 and the second arithmetic processing device 22 perform sampling is 1000 μs, and the output period of the inertial sensor unit 11 is 500 μs.

That is, when the number of arithmetic processing devices is N (=2), the period of 500 μs at which the inertial sensor unit 11 performs output is 1/N of the period of 1000 μs at which each of the arithmetic processing devices performs sampling. Further, the period of 500 μs at which the inertial sensor unit 11 performs output is 1/N of the period of 1000 μs at which each of the arithmetic processing devices performs sampling.

As described above, in the present embodiment, the sampling period of the first arithmetic processing device 21 and the second arithmetic processing device 22 is longer than the output period of the inertial sensor unit 11. However, in the present embodiment, there is adopted a configuration in which the period of the output to the host 30 is prevented from becoming longer than the output period of the inertial sensor unit 11 by shifting the start timing of sampling between the first arithmetic processing device 21 and the second arithmetic processing device 22.

Specifically, the first arithmetic processing device 21 and the second arithmetic processing device 22, which are the two arithmetic processing devices, are configured to start sampling and output the processing result in a predetermined order. In the present embodiment, by the first arithmetic processing device 21 and the second arithmetic processing device 22 alternately performing the processing, the first arithmetic processing device 21 as one of the arithmetic processing devices processes the digital data that starts to be output from the inertial sensor unit 11 in a certain period, and the second arithmetic processing device 22 as the other of the arithmetic processing devices processes the digital data that starts to be output in the subsequent period. Further, the digital data that starts to be output in the subsequent period is processed by the first arithmetic processing device 21. Subsequently, the second arithmetic processing device 22 and the first arithmetic processing device 21 alternately perform the processing.

Further, when one of the two arithmetic processing devices (the first arithmetic processing device 21 and the second arithmetic processing device 22) is defined as an arithmetic processing device that starts sampling in a first order and the other thereof is defined as an arithmetic processing device that starts sampling in a second order, a difference between the timing at which the arithmetic processing device that starts sampling in the first order starts the sampling and the timing at which the arithmetic processing device that starts sampling in the second order starts the sampling, and a difference between the timing at which the arithmetic processing device that starts sampling in the first order outputs the processing result and the timing at which the arithmetic processing device that starts sampling in the second order outputs the processing result are shorter than a period at which the sampling is performed in a single arithmetic processing device. Specifically, in the present embodiment, the difference between the timing at which the first arithmetic processing device 21 starts the sampling and the timing at which the second arithmetic processing device 22 starts the sampling is 500 μs, and the difference is 1/N of the sampling period of 1000 μs of the first arithmetic processing device 21 and the second arithmetic processing device 22.

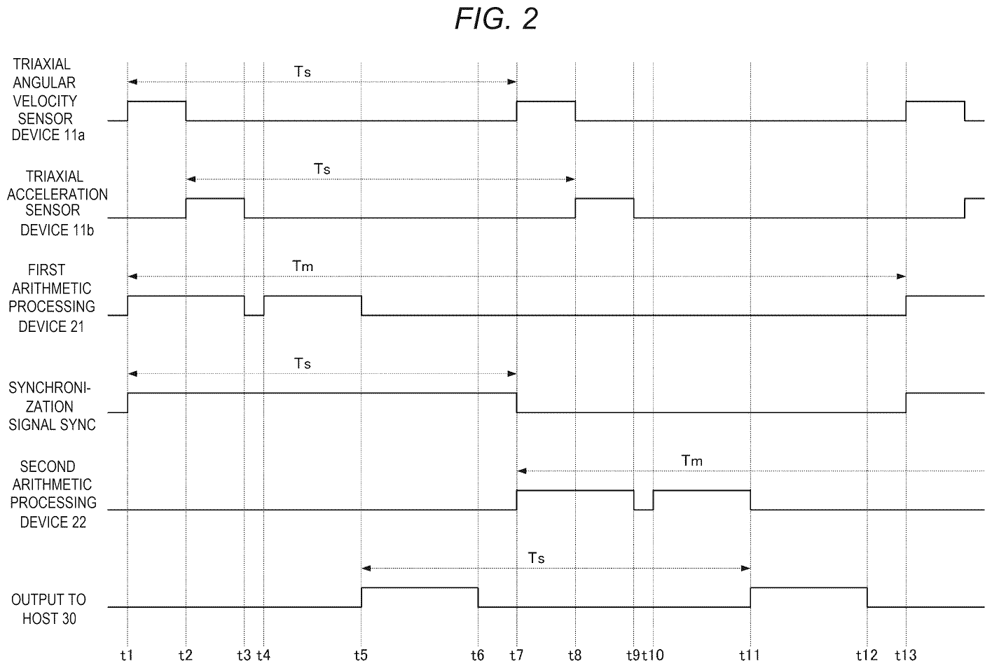

FIG. 2 is a timing chart of operations and so on of the elements of the inertial sensor module 10 according to the present embodiment. In FIG. 2, six types of timings are shown in a time-series manner. The first and second timing charts from the top respectively show data communication operations of the triaxial angular velocity sensor device 11a and the triaxial acceleration sensor device 11b. The third and fifth timing charts from the top respectively show operations of the first arithmetic processing device 21 and the second arithmetic processing device 22. The fourth timing chart from the top shows the synchronization signal SYNC output from the first arithmetic processing device 21 to the second arithmetic processing device 22. The sixth timing chart from the top shows signal output from the inertial sensor module 10 to the host 30.

The triaxial angular velocity sensor device 11a and the triaxial acceleration sensor device 11b output the detection values at a period Ts (500 μs) in accordance with instructions from the first arithmetic processing device 21 and the second arithmetic processing device 22. For example, in FIG. 2, the triaxial angular velocity sensor device 11a starts outputting the digital data representing the angular velocities at a timing t1, and the output is completed at a timing t2. Then, the output of the digital data is started again at a timing t7 when the period Ts elapses from the timing t1.

Further, in FIG. 2, the triaxial acceleration sensor device 11b starts outputting the digital data representing the acceleration values at the timing t2, and the output of the digital data is completed at a timing t3. Then, the output of the digital data is started again at a timing t8 when the period Ts elapses from the timing t2.

When the triaxial angular velocity sensor device 11a outputs the digital data representing the angular velocities in the period from the timing t1 to the timing t2, the first arithmetic processing device 21 acquires the digital data in the period from the timing t1 to the timing t2. Similarly, when the triaxial acceleration sensor device 11b outputs the digital data representing the acceleration values in the period from the timing t2 to the timing t3, the first arithmetic processing device 21 acquires the digital data in the period from the timing t2 to the timing t3. On the other hand, the second arithmetic processing device 22 does not acquire the digital data between the timings t1 to t3.

When the first arithmetic processing device 21 acquires the digital data between the timings t1 to t3, the processing unit 21b of the first arithmetic processing device 21 performs processing such as correction based on the digital data acquired. In the example illustrated in FIG. 2, the first arithmetic processing device 21 performs that processing between timings t4 to t5. When that processing is completed, the processing unit 21b outputs the digital data processed to the host 30 via the second interface 21d. In the example illustrated in FIG. 2, the output of the digital data to the host 30 is illustrated in the sixth timing chart from the top, and is performed between timings t5 to t6.

The first arithmetic processing device 21 operates at a period Tm having a length twice the period Ts of the output of the digital data from the inertial sensor unit 11. That is, the first arithmetic processing device 21 starts the acquisition of the digital data again at a timing t13 after the period Tm elapses from the timing t1 at which the acquisition of the digital data starts.

Note that the first arithmetic processing device 21 also generates the synchronization signal SYNC. In the present embodiment, when the acquisition of the digital data output from the triaxial angular velocity sensor device 11a is started, the first arithmetic processing device 21 changes the signal level of the synchronization signal SYNC from a low level to a high level. Further, the first arithmetic processing device 21 starts counting the time at the timing t1, and when the period Ts at which the triaxial angular velocity sensor device 11a outputs the digital data elapses after the timing t1, the first arithmetic processing device 21 changes the signal level of the synchronization signal SYNC to the low level. In the example illustrated in FIG. 2, the synchronization signal SYNC changes from the high level to the low level at the timing t7.

When the synchronization signal SYNC changes from the high level to the low level, the second arithmetic processing device 22 starts acquiring the digital data. Specifically, when the triaxial angular velocity sensor device 11a outputs the digital data representing the angular velocities in the period from the timing t7 to the timing t8, the second arithmetic processing device 22 acquires the digital data in the period from the timing t7 to the timing t8. Similarly, when the triaxial acceleration sensor device 11b outputs the digital data representing the acceleration values in the period from the timing t8 to the timing t9, the second arithmetic processing device 22 acquires the digital data in the period from the timing t8 to the timing t9. On the other hand, the first arithmetic processing device 21 does not acquire the digital data between the timings t7 to t9.

When the second arithmetic processing device 22 acquires the digital data between the timings t7 to t9, a processing unit 22b of the second arithmetic processing device 22 performs the processing such as correction based on the digital data thus acquired. In the example illustrated in FIG. 2, the second arithmetic processing device 22 performs the processing between the timings t10 to t11. When that processing is completed, the processing unit 22b outputs the digital data processed to the host 30 via the second interface 22d. In the example illustrated in FIG. 2, the output of the digital data to the host 30 is illustrated in the sixth timing chart from the top, and is performed between timings t11 to t12.

Note that the second arithmetic processing device 22 also operates at the period Im having a length twice the period Ts of the output of the digital data from the inertial sensor unit 11. Therefore, the second arithmetic processing device 22 starts acquiring the digital data again at a timing (not illustrated) after the period Tm elapses from the timing t7 of starting acquiring the digital data.

As described above, the first arithmetic processing device 21 and the second arithmetic processing device 22 operate at the period twice the output period of the digital data of the triaxial angular velocity sensor device 11a and the triaxial acceleration sensor device 11b. Further, the first arithmetic processing device 21 and the second arithmetic processing device 22 operate at the same period, but the start timings of the acquisition of the digital data are shifted from each other by a time length (=the period Ts) of ½ of the operation period of the first arithmetic processing device 21 and the second arithmetic processing device 22.

As a result, as shown in FIG. 2, the output period of the digital data to the host 30 becomes the period Ts which is ½ of the operation period of the first arithmetic processing device 21 and the second arithmetic processing device 22. Therefore, the operation period of each of the first arithmetic processing device 21 and the second arithmetic processing device 22 is longer than the operation period of the inertial sensor unit 11, but the operation period of the entire inertial sensor module 10 viewed from the host 30 is equivalent to the operation period of the inertial sensor unit 11.

In the above configuration, the two arithmetic processing devices alternately start the sampling and output the processing results. Therefore, it is not necessary to process the digital data output from the inertial sensor unit 11 with a single processing device, and the configuration of the arithmetic processing device can be simplified.

Further, the difference between the timing at which the first arithmetic processing device 21 that starts sampling in the first order starts the sampling and the timing at which the second arithmetic processing device 22 that starts sampling in the second order starts the sampling, and the difference between the timing at which the first arithmetic processing device 21 that starts sampling in the first order outputs the processing result and the timing at which the second arithmetic processing device 22 that starts sampling in the second order outputs the processing result are shorter than the period at which the sampling is performed in a single arithmetic processing device. Therefore, it is possible to output the digital data from the inertial sensor module 10 at a period shorter than the operation period of the arithmetic processing device.

Further, the period Ts at which the inertial sensor unit 11 performs output is 1/2 of the period Tm at which each of the arithmetic processing devices performs sampling. According to this configuration, the inertial sensor module 10 that operates at the same period as the operation period of the inertial sensor unit 11 can be configured using the arithmetic processing devices having the operation period longer than the output period of the inertial sensor unit 11. Therefore, it is possible to configure a sensor module that operates at high speed with a simple configuration.

### (2) Second Embodiment

In the first embodiment described above, the sampling period of the first arithmetic processing device 21 and the second arithmetic processing device 22 is longer than the period at which the inertial sensor unit 11 performs output, but the former period may be equivalent to the latter period. In this case, the period at which the inertial sensor module 10 performs output can be made shorter than the period at which the inertial sensor unit 11 performs output.

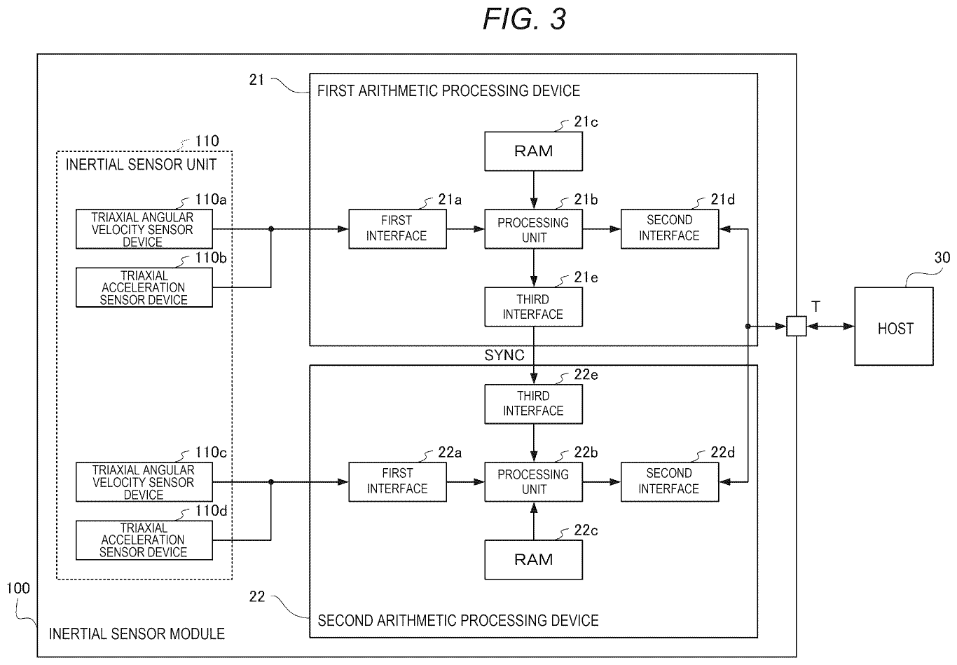

FIG. 3 is a block diagram showing an inertial sensor module 100 according to such an example. Note that in FIG. 3, substantially the same elements as those in FIG. 1 are denoted by the same reference numerals. That is, in the inertial sensor module 100, a configuration of an inertial sensor unit 110 is different from the configuration shown in FIG. 1. The inertial sensor unit 110 provided to the inertial sensor module 100 includes triaxial angular velocity sensor devices 110a, 110c and triaxial acceleration sensor devices 110b, 110d.

The triaxial angular velocity sensor devices 110a, 110c are each substantially the same in configuration as the triaxial angular velocity sensor device 11a, and the triaxial acceleration sensor devices 110b, 110d are each substantially the same in configuration as the triaxial acceleration sensor device 11b. The triaxial angular velocity sensor devices 110a, 110c are two inertial sensor devices that measure the same measurement target. That is, the triaxial angular velocity sensor device 110a includes sensor elements that detect angular velocities in rotational directions around respective rotational axes corresponding to three axes perpendicular to each other, and the triaxial angular velocity sensor device 110c includes sensor elements that detect angular velocities in rotational directions around respective rotational axes corresponding to the same three axes perpendicular to each other. The triaxial angular velocity sensor devices 110a, 110c each detect, for example, the angular velocity around the X axis, the angular velocity around the Y axis, and the angular velocity around the Z axis. The triaxial acceleration sensor devices 110b, 110d are two inertial sensor devices that measure the same measurement target. That is, the triaxial acceleration sensor device 110b includes sensor elements each detecting acceleration in a direction along each of the three axes perpendicular to each other, and the triaxial acceleration sensor device 110d includes sensor elements each detecting acceleration in a direction along each of the same three axes perpendicular to each other. The triaxial acceleration sensor devices 110b, 110d each detect, for example, the acceleration in the X-axis direction, the acceleration in the Y-axis direction, and the acceleration in the Z-axis direction.

In the inertial sensor module 100, each of the two arithmetic processing devices (the first arithmetic processing device 21 and the second arithmetic processing device 22) is coupled to respective inertial sensor devices different from each other among the two inertial sensor devices that measure the same measurement target. Specifically, the triaxial angular velocity sensor device 110a is coupled to the first interface 21a of the first arithmetic processing device 21 but is not coupled to the first interface 22a of the second arithmetic processing device 22. Further, the triaxial angular velocity sensor device 110c is coupled to the first interface 22a of the second arithmetic processing device 22 but is not coupled to the first interface 21a of the first arithmetic processing device 21.

Further, the triaxial acceleration sensor device 110b is coupled to the first interface 21a of the first arithmetic processing device 21 but is not coupled to the first interface 22a of the second arithmetic processing device 22. Further, the triaxial acceleration sensor device 110d is coupled to the first interface 22a of the second arithmetic processing device 22 but is not coupled to the first interface 21a of the first arithmetic processing device 21. Note that the triaxial angular velocity sensor device 110a and the triaxial acceleration sensor device 110b are coupled to the first interface 21a using common signal lines. The triaxial angular velocity sensor device 110c and the triaxial acceleration sensor device 110d are coupled to the first interface 22a using common signal lines.

In the inertial sensor module 100, a period at which the inertial sensor unit 110 performs output is the same as a period at which a single arithmetic processing device, that is, each of the first arithmetic processing device 21 and the second arithmetic processing device 22 performs sampling. Further, the difference between the timing at which the arithmetic processing device (e.g., the first arithmetic processing device 21) that starts sampling in the first order starts the sampling and the timing at which the arithmetic processing device (e.g., the second arithmetic processing device 22) that starts sampling in the second order starts the sampling is ½ of the period at which each of the arithmetic processing devices performs sampling.

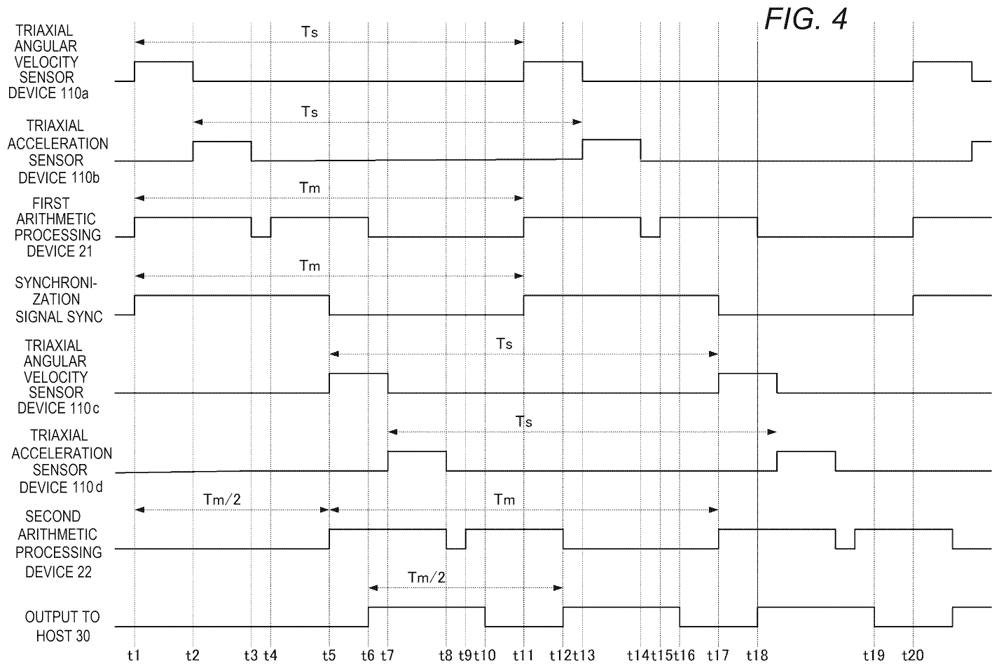

FIG. 4 is a timing chart of operations and so on of the elements of the inertial sensor module 100. In FIG. 4, eight types of timings are shown in a time-series manner. The first, second, fifth, and sixth timing charts from the top show data communication operations of the triaxial angular velocity sensor device 110a, the triaxial acceleration sensor device 110b, the triaxial angular velocity sensor device 110c, and the triaxial acceleration sensor device 110d, respectively. The third and seventh timing charts from the top show the operations of the first arithmetic processing device 21 and the second arithmetic processing device 22, respectively. The fourth timing chart from the top shows the synchronization signal SYNC output from the first arithmetic processing device 21 to the second arithmetic processing device 22. The eighth timing chart from the top shows signal output from the inertial sensor module 100 to the host 30.

The triaxial angular velocity sensor devices 110a, 110c and the triaxial acceleration sensor devices 110b, 110d output the detection values at the period Ts (e.g., 500 us). For example, in FIG. 4, the triaxial angular velocity sensor device 110a starts outputting the digital data representing the angular velocities at a timing t1, and the output is completed at a timing t2. Then, the output of the digital data is started again at a timing t11 when the period Ts elapses from the timing t1.

Further, in FIG. 4, the triaxial acceleration sensor device 110b starts outputting the digital data representing the acceleration values at the timing t2, and the output of the digital data is completed at a timing t3. Then, the output of the digital data is started again at a timing t13 when the period Ts elapses from the timing t2.

When the triaxial angular velocity sensor device 110a outputs the digital data representing the angular velocities in the period from the timing t1 to the timing t2, the first arithmetic processing device 21 acquires the digital data in the period from the timing t1 to the timing t2. Similarly, when the triaxial acceleration sensor device 110b outputs the digital data representing the acceleration values in the period from the timing t2 to the timing t3, the first arithmetic processing device 21 acquires the digital data in the period from the timing t2 to the timing t3.

When the first arithmetic processing device 21 acquires the digital data between the timings t1 to t3, the processing unit 21b of the first arithmetic processing device 21 performs processing such as correction based on the digital data acquired. In the example illustrated in FIG. 4, the first arithmetic processing device 21 performs the processing between the timings t4 to t6. When that processing is completed, the processing unit 21b outputs the digital data processed to the host 30 via the second interface 21d. In the example illustrated in FIG. 4, the output of the digital data to the host 30 is illustrated in the sixth timing chart from the top, and is performed between timings t6 to t10.

In the present embodiment, the first arithmetic processing device 21 operates at a period Tm the same in length as the period Ts of the digital data output from the inertial sensor unit 11. That is, the first arithmetic processing device 21 starts the acquisition of the digital data again at the timing t11 after the period Tm elapses from the timing t1 at which the acquisition of the digital data starts.

Note that the first arithmetic processing device 21 also generates the synchronization signal SYNC. In the present embodiment, when the acquisition of the digital data output from the triaxial angular velocity sensor device 110a is started, the first arithmetic processing device 21 changes the signal level of the synchronization signal SYNC from a low level to a high level. Further, the first arithmetic processing device 21 starts counting the time at the timing t1, and when ½ of the period Ts at which the triaxial angular velocity sensor device 110a outputs the digital data elapses after the timing t1, the first arithmetic processing device 21 changes the signal level of the synchronization signal SYNC to the low level. In the example illustrated in FIG. 4, the synchronization signal SYNC changes from the high level to the low level at the timing t5.

When the synchronization signal SYNC changes from the high level to the low level, the second arithmetic processing device 22 starts acquiring the digital data. Specifically, when the triaxial angular velocity sensor device 110c outputs the digital data representing the angular velocities in the period from the timing t5 to the timing t7, the second arithmetic processing device 22 acquires the digital data in the period from the timing t5 to the timing t7. Similarly, when the triaxial acceleration sensor device 110d outputs the digital data representing the acceleration values in the period from the timing t7 to the timing t8, the second arithmetic processing device 22 acquires that digital data in the period from the timing t7 to the timing t8.

When the second arithmetic processing device 22 acquires the digital data between the timings t5 to t8, the processing unit 22b of the second arithmetic processing device 22 performs processing such as correction based on the digital data acquired. In the example illustrated in FIG. 4, the second arithmetic processing device 22 performs that processing between the timings t9 to t12. When that processing is completed, the processing unit 22b outputs the digital data processed to the host 30 via the second interface 22d. In the example illustrated in FIG. 4, the output of the digital data to the host 30 is illustrated in the sixth timing chart from the top, and is performed between timings t12 to t16.

Note that the second arithmetic processing device 22 also operates at the period Tm the same in length as the period Ts of the digital data output from the inertial sensor unit 11. Therefore, the second arithmetic processing device 22 starts the acquisition of the digital data again at a timing t17 after the period Tm elapses from the timing t5 of the start of the acquisition of the digital data.

As described above, the first arithmetic processing device 21 and the second arithmetic processing device 22 operate at the same period as the output period of the digital data of the triaxial angular velocity sensor device 110a, the triaxial acceleration sensor device 110b, the triaxial angular velocity sensor device 110c, and the triaxial acceleration sensor device 110d. Further, the first arithmetic processing device 21 and the second arithmetic processing device 22 operate at the same period, but the start timings of the digital data acquisition are shifted from each other by Tm/2 (=Ts/2) which is a time length ½ of the operation period Tm of the first arithmetic processing device 21 and the second arithmetic processing device 22.

As a result, as illustrated in FIG. 4, the output period of the digital data to the host 30 becomes the period Tm/2 (=Ts/2) which is ½ of the operation period of the first arithmetic processing device 21 and the second arithmetic processing device 22. Therefore, the operation period of each of the first arithmetic processing device 21 and the second arithmetic processing device 22 is the same as the operation period of the inertial sensor unit 110, but the operation period of the entire inertial sensor module 100 viewed from the host 30 is shorter than the operation period of the first arithmetic processing device 21 and the second arithmetic processing device 22. That is, the increase in operation speed can be achieved.

In the above configuration, the two arithmetic processing devices alternately start the sampling and output the processing results. Therefore, it is not necessary to process the digital data output from the inertial sensor unit 110 with a single processing device, and the configuration of the arithmetic processing device can be simplified.

Further, the difference between the timing at which the first arithmetic processing device 21 that starts sampling in the first order starts the sampling and the timing at which the second arithmetic processing device 22 that starts sampling in the second order starts the sampling, and the difference between the timing at which the first arithmetic processing device 21 that starts sampling in the first order outputs the processing result and the timing at which the second arithmetic processing device 22 that starts sampling in the second order outputs the processing result are shorter than the period at which the sampling is performed in a single arithmetic processing device. Therefore, it is possible to output the digital data from the inertial sensor module 100 at a period shorter than the operation period of the arithmetic processing device.

Further, the period Ts at which the inertial sensor unit 110 performs the output is the same as the period Tm at which a single arithmetic processing device performs the sampling, but the difference between the timings at which the respective arithmetic processing devices start the sampling is ½ of the period Tm at which the single arithmetic processing device performs the sampling. According to this configuration, the inertial sensor module 100 that performs output at a shorter period than the operation period of the arithmetic processing device can be configured using the arithmetic processing device having the equivalent operation period to that of the inertial sensor unit 110. Therefore, it is possible to configure a sensor module that operates at high speed with a simple configuration.

### (3) Third Embodiment

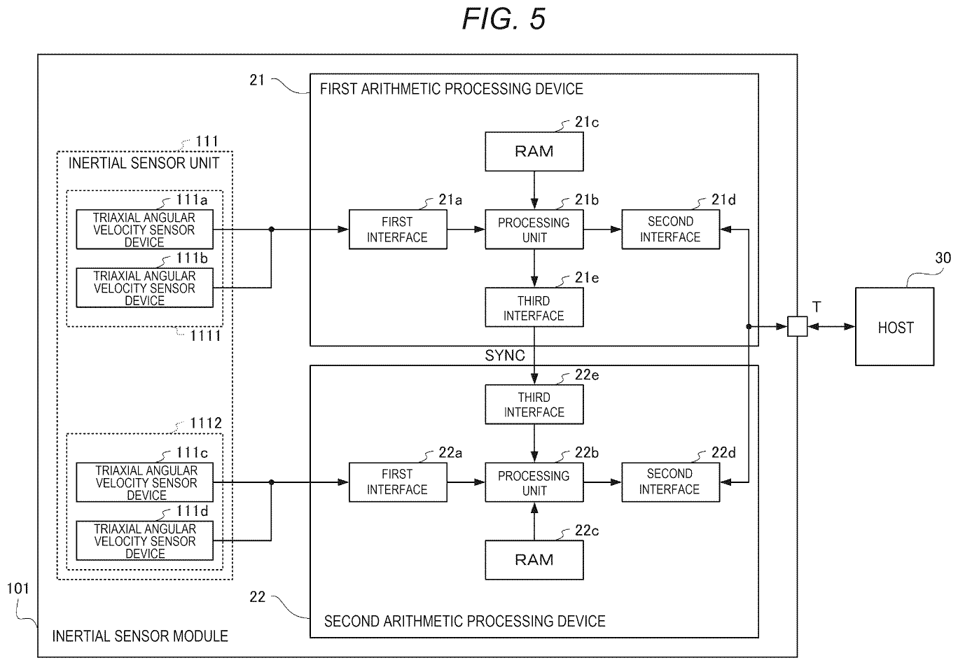

Further, a configuration in which the detection result of the same measurement target is input to a single arithmetic processing device may be adopted. In this case, it is possible to achieve an increase in accuracy by statistically processing the measurement results of the same measurement target in the arithmetic processing device. FIG. 5 is a block diagram showing an inertial sensor module 101 according to such an example. Note that in FIG. 5, substantially the same elements as those in FIG. 1 are denoted by the same reference numerals.

That is, in the inertial sensor module 101, a configuration of an inertial sensor unit 111 is different from the configuration shown in FIG. 1. The inertial sensor unit 111 provided to the inertial sensor module 101 includes triaxial angular velocity sensor devices 111a, 111b, 111c, and 111d.

The triaxial angular velocity sensor devices 111a, 111b, 111c, and 111d are substantially the same in configuration as the triaxial angular velocity sensor device 11a. The triaxial angular velocity sensor devices 111a, 111b, 111c, and 111d are four inertial sensor devices that measure the same measurement target. That is, each of the triaxial angular velocity sensor devices 111a, 111b, 111c, and 111d includes sensor elements that measure respective angular velocities in rotational directions around rotational axes corresponding to the same three axes perpendicular to each other.

In the present embodiment, the triaxial angular velocity sensor devices 111a, 111b are coupled to the first interface 21a of the first arithmetic processing device 21. Further, the triaxial angular velocity sensor devices 111c, 111d are coupled to the first interface 22a of the second arithmetic processing device 22. Here, a plurality of sensor devices coupled to the same arithmetic processing device is referred to as an inertial sensor device group. In the case of the example shown in FIG. 5, the triaxial angular velocity sensor devices 111a, 111b are one inertial sensor device group 1111, and the triaxial angular velocity sensor devices 111c, 111d are another inertial sensor device group 1112.

As described above, the inertial sensor unit 111 according to the present embodiment includes the two inertial sensor device groups 1111, 1112 including the plurality of inertial sensor devices that measure the angular velocities around the three axes as the same measurement target. Further, the two arithmetic processing devices (the first arithmetic processing device 21 and the second arithmetic processing device 22) are coupled to respective inertial sensor device groups different from each other out of the two inertial sensor device groups.

Note that the triaxial angular velocity sensor devices 111a, 111b belonging to the inertial sensor device group 1111 are not coupled to the second arithmetic processing device 22, and the triaxial angular velocity sensor devices 111c, 111d belonging to the inertial sensor device group 1112 are not coupled to the first arithmetic processing device 21. Further, the triaxial angular velocity sensor devices 111a, 111b are coupled to the first interface 21a using common signal lines. The triaxial angular velocity sensor devices 111c, 111d are coupled to the first interface 22a using common signal lines.

In the inertial sensor module 101, a period Ts at which the inertial sensor unit 111 performs output is the same as a period Tm at which a single arithmetic processing device, that is, each of the first arithmetic processing device 21 and the second arithmetic processing device 22 performs sampling. Further, the difference between the timing at which the arithmetic processing device (e.g., the first arithmetic processing device 21) that starts sampling in the first order starts the sampling and the timing at which the arithmetic processing device (e.g., the second arithmetic processing device 22) that starts sampling in the second order starts the sampling is ½ (=Ts/2) of the period Tm at which each of the arithmetic processing devices performs sampling.

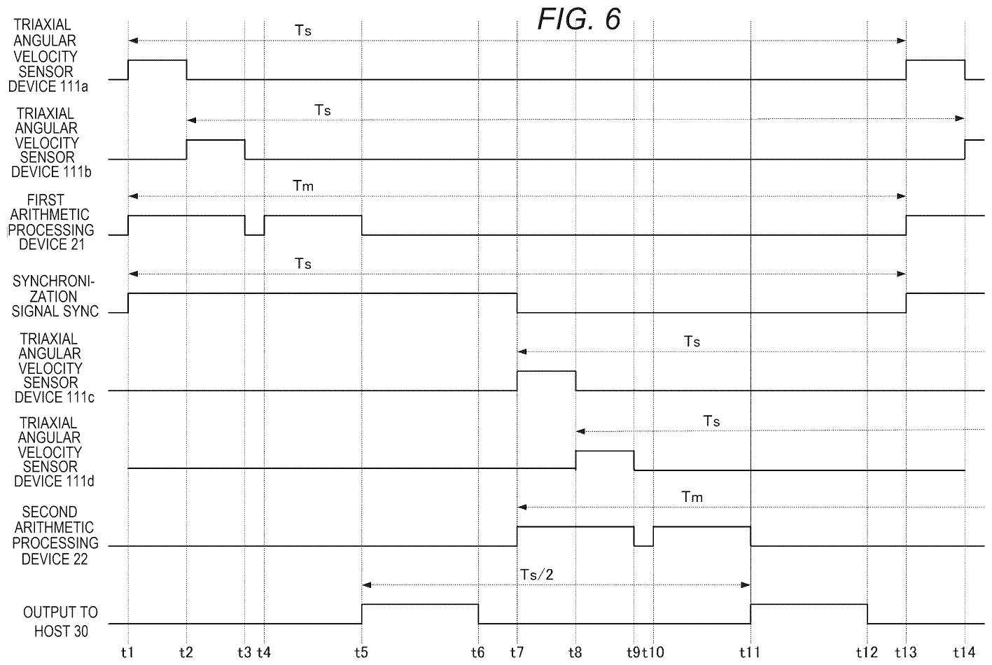

FIG. 6 is a timing chart of operations and so on of the elements of the inertial sensor module 101. In FIG. 6, eight types of timings are shown in a time-series manner. The first, second, fifth, and sixth timing charts from the top show the operations of the triaxial angular velocity sensor devices 111a, 111b, 111c, and 111d, respectively. The third and seventh timing charts from the top show the operations of the first arithmetic processing device 21 and the second arithmetic processing device 22, respectively. The fourth timing chart from the top shows the synchronization signal SYNC output from the first arithmetic processing device 21 to the second arithmetic processing device 22. The eighth timing chart from the top shows signal output from the inertial sensor module 101 to the host 30.

The triaxial angular velocity sensor devices 111a, 111b, 111c, and 111d output the detection values at the period Ts (e.g., 500 us). For example, in FIG. 6, the triaxial angular velocity sensor device 111a starts outputting the digital data representing the angular velocities at a timing t1, and the output is completed at a timing t2. Then, the output of the digital data is started again at a timing t13 when the period Ts elapses from the timing t1. In the example illustrated in FIG. 6, the triaxial angular velocity sensor device 111b starts outputting the digital data representing the angular velocities at the timing t2, the triaxial angular velocity sensor device 111c starts outputting the digital data representing the angular velocities at the timing t7, and the triaxial angular velocity sensor device 111d starts outputting the digital data representing the angular velocities at the timing t8. Further, the output of the digital data is started again at the timings when the period Ts elapses from these timings.

When the triaxial angular velocity sensor device 111a outputs the digital data representing the angular velocities in the period from the timing t1 to the timing t2, the first arithmetic processing device 21 acquires the digital data in the period from the timing t1 to the timing t2. Similarly, when the triaxial angular velocity sensor device 111b outputs the digital data representing the angular velocities in the period from the timing t2 to the timing t3, the first arithmetic processing device 21 acquires the digital data in the period from the timing t2 to the timing t3.

When the first arithmetic processing device 21 acquires the digital data between the timings t1 to t3, the processing unit 21b of the first arithmetic processing device 21 performs processing such as correction based on the digital data acquired. Further, on this occasion, the processing unit 21b of the first arithmetic processing device 21 performs statistic processing of the sampling results of the triaxial angular velocity sensor devices 111a, 111b. That is, the first arithmetic processing device 21 performs a statistic operation of the sampling results of the same measurement target of the inertial sensor device group 1111 coupled to the first arithmetic processing device 21. That statistic operation may be in various forms, and can be realized by, for example, processing of calculating an average value, a median value, or the like for each axis based on the detection values of the angular velocities around the three axes. By performing such a statistic operation, the value of the angular velocity around each of the three axes can be obtained with high accuracy.

In the example illustrated in FIG. 6, the first arithmetic processing device 21 performs that processing between the timings t4 to t5. When that processing is completed, the processing unit 21b outputs the digital data processed to the host 30 via the second interface 21d. In the example illustrated in FIG. 6, the output of the digital data to the host 30 is illustrated in the sixth timing chart from the top, and is performed between the timings t5 to t6.

In the present embodiment, the first arithmetic processing device 21 operates at a period Tm the same in length as the period Ts of the digital data output from the inertial sensor unit 11. That is, the first arithmetic processing device 21 starts the acquisition of the digital data again at a timing t13 after the period Tm elapses from the timing t1 at which the acquisition of the digital data starts.

Note that the first arithmetic processing device 21 also generates the synchronization signal SYNC. In the present embodiment, when the acquisition of the digital data output from the triaxial angular velocity sensor device 111a is started, the first arithmetic processing device 21 changes the signal level of the synchronization signal SYNC from a low level to a high level. Further, the first arithmetic processing device 21 starts counting the time at the timing t1, and when ½ (=Tm/2) of the period Ts at which the triaxial angular velocity sensor device 111a outputs the digital data elapses after the timing t1, the first arithmetic processing device 21 changes the signal level of the synchronization signal SYNC to the low level. In the example illustrated in FIG. 6, the synchronization signal SYNC changes from the high level to the low level at the timing t7.

When the synchronization signal SYNC changes from the high level to the low level, the second arithmetic processing device 22 starts acquiring the digital data. Specifically, when the triaxial angular velocity sensor device 111c outputs the digital data representing the angular velocities in the period from the timing t7 to the timing t8, the second arithmetic processing device 22 acquires the digital data in the period from the timing t7 to the timing t8. Similarly, when the triaxial angular velocity sensor device 111d outputs the digital data representing the angular velocities in the period from the timing t8 to the timing t9, the second arithmetic processing device 22 acquires the digital data in the period from the timing t8 to the timing t9.

When the second arithmetic processing device 22 acquires the digital data between the timings t7 to t9, the processing unit 22b of the second arithmetic processing device 22 performs the processing such as correction based on the digital data thus acquired. Further, on this occasion, the processing unit 22b of the second arithmetic processing device 22 performs statistic processing of the sampling results of the triaxial angular velocity sensor devices 111c, 111d. That is, the second arithmetic processing device 22 performs a statistic operation of the sampling results of the same measurement target of the inertial sensor device group 1112 coupled to the second arithmetic processing device 22. That statistic operation may be in various forms, and can be realized by, for example, processing of calculating an average value, a median value, or the like for each axis based on the detection values of the angular velocities around the three axes. By performing such a statistic operation, the value of the angular velocity around each of the three axes can be obtained with high accuracy.

In the example illustrated in FIG. 6, the second arithmetic processing device 22 performs that processing between the timings t10 to t11. When that processing is completed, the processing unit 22b outputs the digital data processed to the host 30 via the second interface 22d. In the example illustrated in FIG. 6, the output of the digital data to the host 30 is illustrated in the sixth timing chart from the top, and is performed between the timings t11 to t12.

Note that the second arithmetic processing device 22 also operates at the period Tm the same in length as the period Ts of the digital data output from the inertial sensor unit 11. Therefore, the second arithmetic processing device 22 starts acquiring the digital data again at a timing (not illustrated) after the period Tm elapses from the timing t7 of starting acquiring the digital data. As described above, the first arithmetic processing device 21 and the second arithmetic processing device 22 operate at the same period as the output period of the digital data of the triaxial angular velocity sensor devices 111a, 111b, 111c, and 111d. Further, the first arithmetic processing device 21 and the second arithmetic processing device 22 operate at the same period, but the start timings of the acquisition of the digital data are shifted from each other by a time length (=the period Ts/2) of ½ of the operation period of the first arithmetic processing device 21 and the second arithmetic processing device 22.

As a result, as shown in FIG. 6, the output period of the digital data to the host 30 becomes the period Ts/2 which is ½ of the operation period of the first arithmetic processing device 21 and the second arithmetic processing device 22. Therefore, the operation period of each of the first arithmetic processing device 21 and the second arithmetic processing device 22 is the same as the operation period of the inertial sensor unit 111, but the operation period of the entire inertial sensor module 101 viewed from the host 30 is shorter than the operation period of the inertial sensor unit 111. Further, in the present embodiment, since the statistical value of the detection results of the same measurement target is output from the inertial sensor module 101, it is possible to achieve highly accurate output value.

In the above configuration, the two arithmetic processing devices alternately start the sampling and output the processing results. Therefore, it is not necessary to process the digital data output from the inertial sensor unit 111 with a single processing device, and the configuration of the arithmetic processing device can be simplified.

Further, the difference between the timing at which the first arithmetic processing device 21 that starts sampling in the first order starts the sampling and the timing at which the second arithmetic processing device 22 that starts sampling in the second order starts the sampling, and the difference between the timing at which the first arithmetic processing device 21 that starts sampling in the first order outputs the processing result and the timing at which the second arithmetic processing device 22 that starts sampling in the second order outputs the processing result are shorter than the period at which the sampling is performed in a single arithmetic processing device. Therefore, it is possible to output the digital data from the inertial sensor module 101 at a period shorter than the operation period of the arithmetic processing device.

Further, the period Ts at which the inertial sensor unit 111 performs output is the same as the period Tm at which each of the arithmetic processing devices performs sampling. Further, the difference between the timings at which the arithmetic processing devices start sampling is ½ of the period Tm at which each of the arithmetic processing devices performs sampling. According to this configuration, the inertial sensor module 101 that operates at a period shorter than the operation period of the inertial sensor unit 111 can be configured using the arithmetic processing device the same in operation period as the inertial sensor unit 111.

### (4) Fourth Embodiment

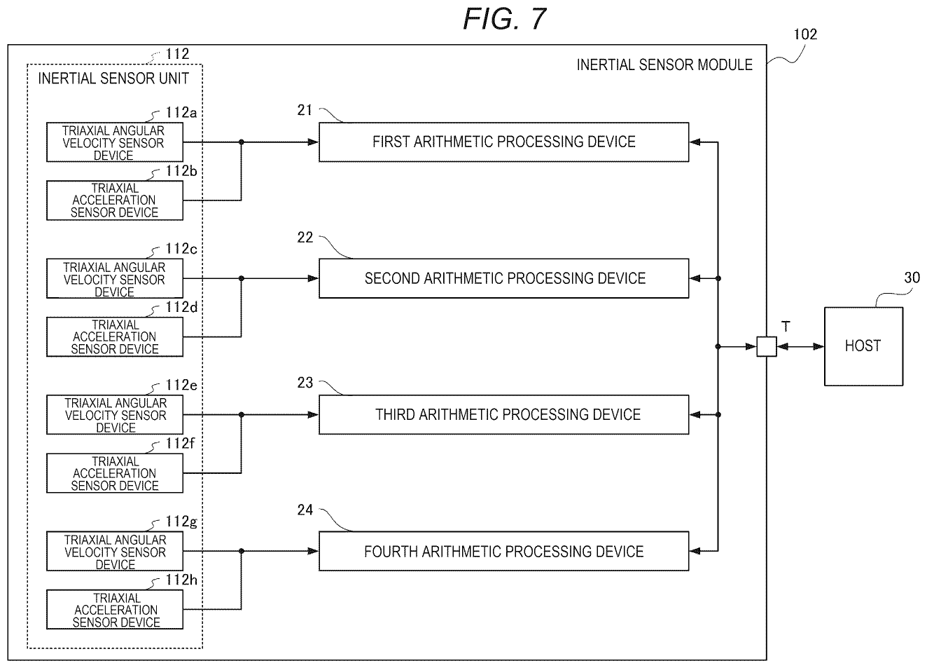

Further, it is sufficient for the number of arithmetic processing devices to be no smaller than two (N as an integer no smaller than two), and the number of arithmetic processing devices is not limited to two. FIG. 7 is a block diagram showing a configuration of an inertial sensor module 102 including four arithmetic processing devices (the first arithmetic processing device 21 to a fourth arithmetic processing device 24). In the inertial sensor module 102, a triaxial angular velocity sensor device and a triaxial acceleration sensor device are coupled to each of the four arithmetic processing devices, that is, the first arithmetic processing device 21 to the fourth arithmetic processing device 24. Therefore, the inertial sensor module 102 shown in FIG. 7 has a configuration in which the number of arithmetic processing devices and the number of sensor devices are doubled in the inertial sensor module 100 shown in FIG. 3.

In such a configuration, by making the output period of each sensor device and the sampling period of each arithmetic processing device the same as each other, it is possible to configure the inertial sensor module 102 that operates at a period the same as or shorter than the output period of the sensor device. For example, it is assumed that the output period Ts of each sensor device and the sampling period Tm of each arithmetic processing device are the same, and the first arithmetic processing devices 21 to the fourth arithmetic processing devices 24 starts sampling in the first to fourth orders, respectively. In this configuration, it is assumed that a difference between the timing at which the arithmetic processing device that starts sampling in the m-th order (m is any one of integers 1 to 3) starts the sampling and the timing at which the arithmetic processing device that starts sampling in the (m+1)-th order starts the sampling is Tm/4. According to this configuration, it is possible to configure the inertial sensor module 102 that outputs the digital data at the period Ts/4 which is ¼ of the period Ts.

Further, it is assumed that the output period Ts of each sensor device and the sampling period Tm of each arithmetic processing device are the same, and the first arithmetic processing devices 21 to 23 starts sampling in the first to third orders, respectively. In this configuration, it is assumed that a difference between the timing at which the arithmetic processing device that starts sampling in the m-th order (m is any one of integers 1 to 2) starts sampling and the timing at which the arithmetic processing device that starts sampling in the (m+1)-th order starts the sampling is Tm/3. According to this configuration, it is possible to configure the inertial sensor module 102 that outputs the digital data at the period Ts/3 which is ⅓ of the period Ts. Note that the fourth arithmetic processing device 24 is not required to be used, or the statistic processing may be performed based on the detection result input to that fourth arithmetic processing device 24.

Similarly, by selecting two arithmetic processing devices from the four arithmetic processing devices, that is, the first arithmetic processing device 21 to the fourth arithmetic processing device 24, and setting a difference between the timings at which the respective arithmetic processing devices start sampling to Tm/2, the inertial sensor module 102 that outputs the digital data at the period Ts/2 which is ½ of the period Ts can be configured.

Further, also in the configuration illustrated in FIG. 1, the number of arithmetic processing devices is not limited to two. By increasing the number of arithmetic processing devices and the number of sensor devices shown in FIG. 2 to integer multiples, an inertial sensor module that operates at higher speed or an inertial sensor module that outputs more accurate data can be configured.

### (5) Other Embodiments

The embodiments described above are examples for implementing the present disclosure, and various embodiments can be adopted besides these examples. For example, the configuration of the inertial sensor module is not limited to the configurations described above, and various modifications such as omitting some of the elements or adding other elements can be made. Specifically, it is possible to adopt a configuration in which each sensor device is replaced with a 6DOF sensor device in the configurations shown in FIGS. 1, 3, 5, and 7. Further, in the configuration of FIG. 5, a triaxial acceleration sensor device may be disposed in parallel to each of the triaxial angular velocity sensor devices. Further, the measurement target by the inertial sensor device is not limited to the three axes, and may be two axes, one axis, or the like.

It is sufficient for the inertial sensor unit to be a unit capable of outputting a value for evaluating inertia, and it is sufficient to include one or more inertial sensor devices. The inertial sensor device is a device that includes an inertial sensor and is capable of outputting a detection value by that inertial sensor. It is sufficient for the inertial sensor to be a sensor that detects a value for evaluating the inertia, and the inertial sensor may be, for example, an acceleration sensor, an angular acceleration sensor, or a velocity sensor.

The arithmetic processing device is a device that performs various types of arithmetic processing based on the output from the inertial sensor unit. Specifically, it is sufficient for the arithmetic processing device to be able to perform at least sampling of the output of the inertial sensor unit, processing based on the sampling result, and output of the processing result. Obviously, the arithmetic processing device may be capable of performing other processing such as generation of various signals or processing in accordance with commands from the host.

The sampling includes processing of converting an analog signal as an output of the inertial sensor unit into a digital signal, and is executed at a constant sampling period. When the inertial sensor unit includes a plurality of inertial sensor devices, when the sampling is started, the outputs from the plurality of inertial sensor devices are sequentially captured in a predetermined order.

The processing based on the sampling result may be various types of processing. For example, correction of the output error caused by an alignment of the inertial sensor and so on can be cited besides the correction of the output error caused by the temperature characteristics of the inertial sensor. It is sufficient for the output of the processing result to be performed on other devices which use the output, and the output of the processing result is executed via a predetermined interface. The output may also be performed at the sampling period.

Further, a plurality of arithmetic processing devices is installed in the inertial sensor module. That is, there is adopted the configuration in which two or more arithmetic processing devices sequentially process the output of the inertial sensor unit. According to this configuration, it is sufficient that the performance required for performing the processing at an equivalent period is lowered compared to a configuration in which the output of the inertial sensor unit is processed by a single arithmetic processing device. For example, the sampling period of the arithmetic processing device may be the same as or longer than the period of the output from the inertial sensor unit.

It is sufficient for the predetermined order in which the N arithmetic processing devices start sampling and output the processing results to be determined in advance. That is, when a certain arithmetic processing device performs processing based on the output from the inertial sensor unit, the processing based on the subsequent output from the inertial sensor unit is performed by another arithmetic processing device. According to this configuration, the sampling period required for each arithmetic processing device can be made longer than when the same arithmetic processing device continuously performs the processing, and a high arithmetic processing speed is not required.

What is claimed is:

1. An inertial sensor module comprising:
an inertial sensor unit; and
N (N is an integer no smaller than 2) arithmetic processing devices configured to perform sampling of an output of the inertial sensor unit, processing based on a sampling result, and output of a processing result, wherein
the N arithmetic processing devices are configured to start the sampling and output the processing result in a predetermined order.

2. The inertial sensor module according to claim 1, wherein
a difference between a timing at which the arithmetic processing device that starts the sampling in an m-th order (m is any one of integers 1 to N−1) starts the sampling and a timing at which the arithmetic processing device that starts the sampling in an (m+1)-th order starts the sampling, and a difference between a timing at which the arithmetic processing device that starts the sampling in the m-th order outputs the processing result and a timing at which the arithmetic processing device that starts the sampling in the (m+1)-th order outputs the processing result are shorter than a period at which one of the arithmetic processing devices performs the sampling.

3. The inertial sensor module according to claim 1, wherein
a period at which the inertial sensor unit performs output is 1/N of a period at which one of the arithmetic processing devices performs the sampling.

4. The inertial sensor module according to claim 1, wherein
the N arithmetic processing devices determine a timing to start the sampling based on a common synchronization signal.

5. The inertial sensor module according to claim 1, wherein
the N arithmetic processing devices each include an interface coupled to the inertial sensor unit.

6. The inertial sensor module according to claim 1, wherein
the inertial sensor unit includes N (N is an integer no smaller than 2) inertial sensor devices configured to measure same measurement target, and
the N arithmetic processing devices are coupled to respective inertial sensor devices different from each other out of the N inertial sensor devices.

7. The inertial sensor module according to claim 6, wherein
a period at which the inertial sensor unit performs output is same as a period at which one of the arithmetic processing devices performs the sampling, and
a difference between a timing at which the arithmetic processing device that starts the sampling in an m-th order (m is any one of integers 1 to N−1) starts the sampling and a timing at which the arithmetic processing device that starts the sampling in an (m+1)-th order starts the sampling is 1/N of a period at which one of the arithmetic processing devices performs the sampling.

8. The inertial sensor module according to claim 1, wherein
the inertial sensor unit includes N (N is an integer no smaller than 2) inertial sensor device groups each including a plurality of inertial sensor devices configured to measure same measurement target,
the N arithmetic processing devices are coupled to respective inertial sensor device groups different from each other out of the N inertial sensor device groups, and
each of the N arithmetic processing devices performs statistic processing of sampling results of a same measurement target of the inertial sensor device group coupled to the arithmetic processing device out of the N inertial sensor device groups to output the processing result.
